(19) United States
(12) Patent Application Publication
(10) Pub. No.: US 2017/0096094 A1
(43) Pub. Date: Apr. 6, 2017

(54) Mobile Coin Vault Clamp System

(71) Applicant: Alan Polad, Santa Fe Springs, CA (US)

(72) Inventor: Alan Polad, Santa Fe Springs, CA (US)

(21) Appl. No.: 14/876,780

(22) Filed: Oct. 6, 2015

(51) Int. Cl. B60P 7/135; G08B 13/02

(52) U.S. Cl. CPC B60P 7/135; G08B 13/02

(57) ABSTRACT

A mobile coin vault clamping stall includes one or more cages, each cage sized for confining a mobile coin vault and preventing it from moving. The cages are connected in series, with the gate of one cage opening into an adjacent cage, such that the stall has multiple cages but only one entrance. Each cage includes a side gate and a top gate. A side gate latch and a top gate latch on each cage is operable from the stall exterior. The top gate latch is positioned to lock the side gate in a closed position when the top gate latch is closed, preventing a mobile coin vault contained in the cage from moving. A sensor mounted on each cage detects the presence or absence of a mobile coin vault and is coupled to a computer that alerts a user when a mobile coin vault is installed or removed from the cages.

### BACKGROUND

Municipal and private transit organizations must often handle cash money according to standards set at the state or federal level, in order to preserve their eligibility for state and federal funding. Some aspects of these standards include rules regarding how cash money is held in a transit vehicle and transported from the vehicle for deposit after collection. Typically, for transit agencies that accept cash, including coinage, the currency is stored aboard a vehicle in a locked, inaccessible receptacle.

Once the vehicle is out of service and returns to a secure dispatching area, the locked receptacle is removed and its contents dispensed using a secure transfer mechanism into a vault which is sized to hold a large quantity of bills and coinage. Due to the weight of such vaults, mobile coin vaults were developed, allowing persons to wheel them from a collection area to a storage area, and ultimately to a deposit location. Because mobile coin vaults are capable of holding a substantial amount of metal coinage in addition to bill currency, they are extremely heavy when filled and risk injury from uncontrolled movement. Mobile coin vaults are discussed at length in U.S. patent application Ser. No. 14/541,406, which discloses a braking mechanism to prevent such uncontrolled movement.

Since mobile coin vaults must be securely stored in a location and risk unintended movement when physically transported from one place to another, there is a need for an apparatus into which mobile coin vaults can be installed. There is also a need for an apparatus which is resilient enough to handle the weight of a mobile coin vault filled with coinage. A need also exists for a an apparatus for storing mobile coin vaults that effectively locks them in position, and in which redundant locking mechanisms ensure a mobile coin vault cannot be easily or inadvertently removed.

Ultimately, there is a need for an apparatus that holds and locks multiple mobile coin vaults in position, that facilitates the easy installation and removal of mobile coin vaults, and which interfaces with a computer system for electronically monitoring installation, storage and removal of mobile coin vaults from the apparatus. These and other issues are addressed in the following specification and drawings.

### SUMMARY

A mobile coin vault clamping stall includes at least one cage sized for confining a mobile coin vault therein. The cage includes a side gate and a top gate, each attached to the cage in a hinged arrangement. A releasable side gate latch is operable from a first exterior side of the stall for securing the side gate, and a releasable top gate latch is also operable from a second exterior side of the stall for securing the top gate. In a preferred embodiment, the releasable top gate latch is positioned to lock the side gate latch when the top gate is closed over the mobile coin vault. With the side gate and the top gate closed, the cage prevents the mobile coin vault from rolling.

Preferably the clamping stall will have multiple cages connected in series. The side gate of one cage opens into an adjacent cage, except for the last cage in the series, providing a single entrance for all the cages. For a cage into which the side gate of an adjacent cage opens, a securing mechanism allows the side gate to be held open as mobile coin vaults are moved into and out of the stall. When a side gate is closed, a vertical sliding bar coupled to the first exterior side of the stall is raised, thereby raising bolts that slide into catches on the side gate when the vertical sliding bar is lowered, locking the side gate in place.

To prevent the vertical bar from being lifted when the side gate is locked, a horizontal a horizontal sliding bar coupled to the first exterior side of the stall is positioned to block and unblock movement of the vertical sliding bar by sliding back and forth. The top gate latch is positioned to preserve the horizontal locking bar in a blocking position, so that when the top gate latch is closed, the vertical sliding bar is prevented from being raised.

For ease of operation and to prevent the top gate from falling on a user or a mobile coin vault during installation or removal, the top gate includes a lifting mechanism that biases the top gate to an open position. To facilitate rolling a mobile coin vault into the stall, the stall includes wheeled guides positioned at its entrance. Additional wheeled guides may be present inside the stall. To facilitate smooth insertion and removal of a mobile coin vault, each cage preferably includes top guides that maintain a mobile coin vault in a single direction as it travels through the cage. The top guides are preferably made of a material to avoid scratching the mobile coin vault.

To assist the top guides with orienting the mobile coin vault in position, each cage also preferably includes bottom guides positioned to confine wheels of the mobile coin vault in a single direction. As a mobile coin vault slides through the stall, a sensor arranged to detect the presence of a mobile coin vault in the cage activates when the mobile coin vault reaches the cage into which it will be locked. Preferably multiple sensors are used with each cage having an individual sensor.

One or more of the sensors are coupled to a computer, so that the computer indicates when a mobile coin vault is installed in a cage. The computer also preferably indicates removal of a mobile coin vault from a cage. In other embodiments, a computer may display live images of the stall, and include an alert advising when a mobile coin vault is removed.

### BRIEF DESCRIPTION OF THE FIGURES

FIG. 1 illustrates a perspective view of a mobile coin vault securing stall in a closed and locked position;

FIG. 2 illustrates a front perspective view of the stall in an unlocked and open position for receiving a mobile coin vault;

FIG. 3 illustrates a perspective view of a side gate bolt latch and a top gate locking latch of the stall;

FIG. 4 illustrates a front perspective view of the floor, top guides, bottom guides, and wheeled guides of the stall;

FIG. 5 illustrates a user rolling a first mobile coin vault into the stall;

FIG. 6 illustrates a mobile coin vault locked in a cage of the stall and activating an interactive computer display; and

FIG. 7 illustrates two mobile coin vaults locked in a stall having two respective mobile coin vault cages.

### DESCRIPTION

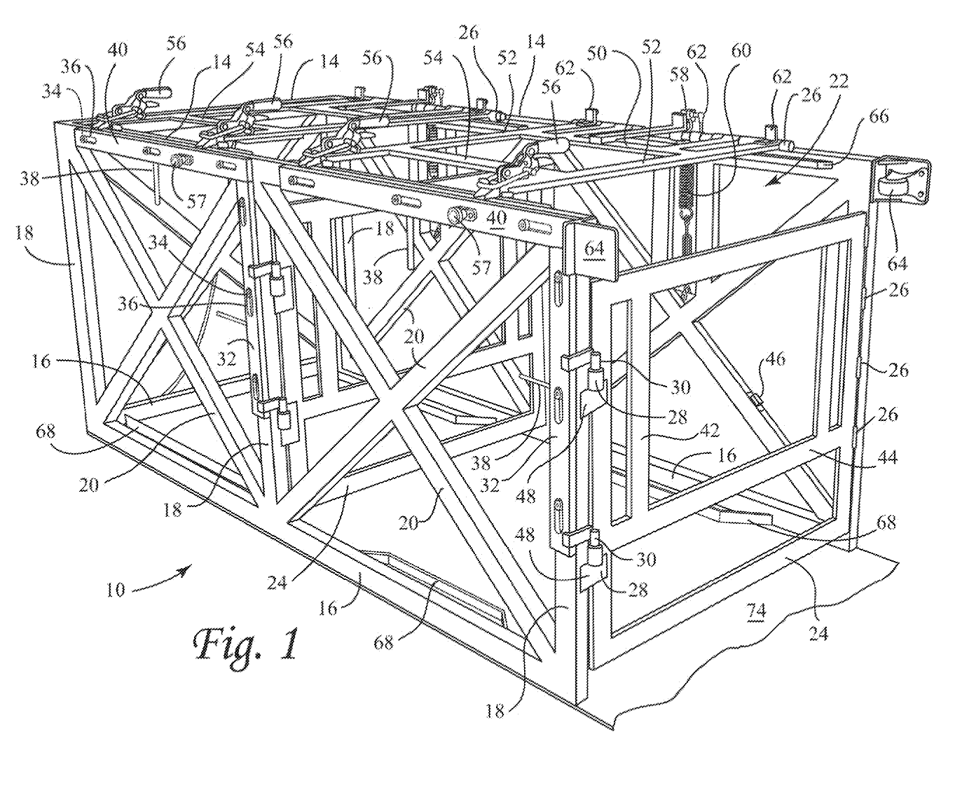

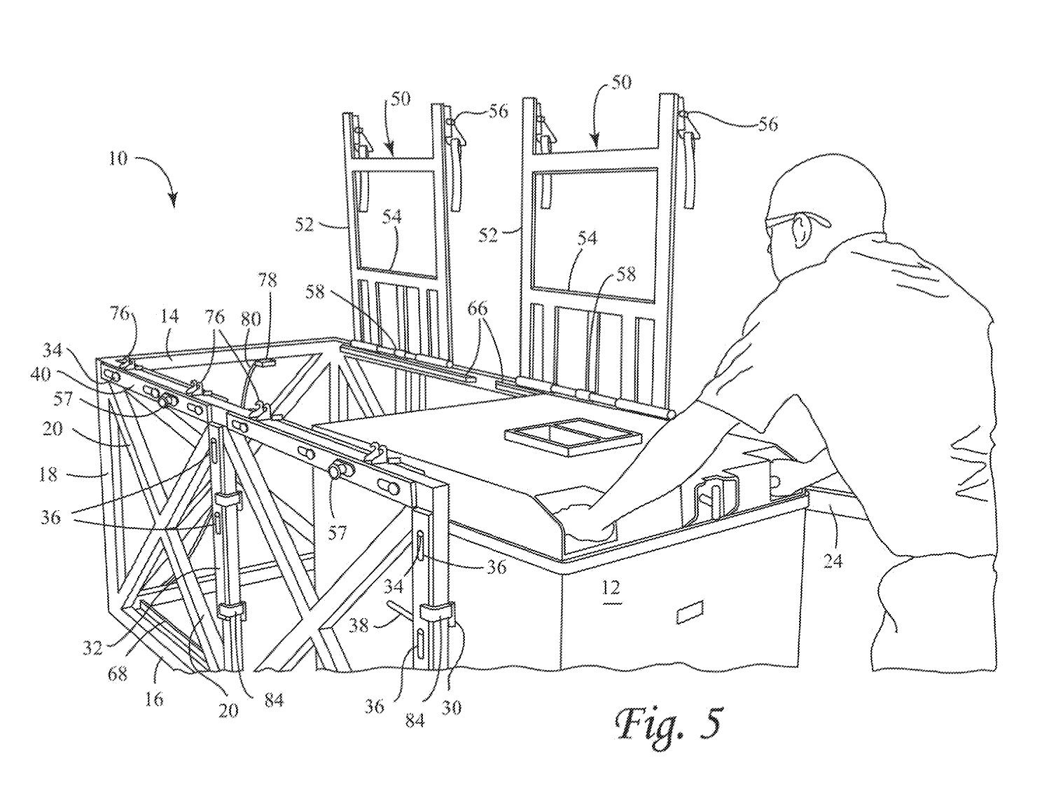

Referring to FIG. 1, a mobile coin vault clamping stall (stall) 10 for securely holding a mobile coin vault 12 (FIGS. 5-7), includes a series of horizontal top beams 14 and bottom beams 16, connected by vertical beams 18, and a series of cross beams 20 to hold multiple mobile coin vaults 12 together in a series of individual cages 22. To ensure secure fastening when installing multiple mobile coin vaults 12, which are very heavy when filled due to coinage and other items, the top beams 14 and bottom beams 16 are preferably elongated, spanning the entire stall 10, with vertical beams 18 and cross beams 20 spaced to create the individual cages 22 in a linear series, allowing mobile coin vaults 12 to be installed end-to-end.

The individual cages 22 are each separated by a locking side gate 24, so that when one mobile coin vault 12 is removed, the next mobile coin vault 12 in line remains locked in the stall 10 until removed by a user. The side gates 24 are affixed to the vertical beams 18 by hinges 26 oriented to allowing the side gates 24 to swing free of the path of travel of a mobile coin vault 12. The side gates 24 are releaseably secured to the vertical beams with one or more bolt latches 28 opposite the hinges 26.

The bolts 30 of the bolt latches 28 ride on a vertical sliding bar 32 to latch and unlatch each side gate 24. The vertical sliding bar 32 is mounted to a vertical beam 18 using pins 34 on the vertical beam 18 that engage slots 36 on the vertical sliding bar 32, thereby confining the movement of the vertical beam 18 to an locked position or an unlocked position. The pins 34 and slots 36 are arranged so that each bolt latch 28 is biased to a locked position when the vertical sliding bar 32 slides down under gravity. A handle 38 coupled to the vertical sliding bar 32 allows a user to move the bolt latches 28 from a locked to an unlocked position.

As a redundant locking mechanism, the vertical sliding bar 32 can be locked into place by a horizontal sliding bar 40 that slides along the top beam 14. The horizontal sliding bar 40 is affixed to the top beam by a pins 34 and slots 36 (similar to the vertical sliding bars 32) that confine movement of the horizontal sliding bar 40 to a locked position above a vertical sliding bar 32 thereby blocking it from sliding upward, and an unlocked position that clears the vertical sliding bar 32, allowing it to move freely. The horizontal sliding bars 40 also have handles 38 (similar to the vertical sliding bars 32) allowing a user to slide them back and forth.

In order to provide strength and resiliency, each side gate 24 includes at least one vertical reinforcing side gate member 42 and at least one horizontal reinforcing side gate member 44 to help prevent the side gates 24 from bending under pressure from an installed mobile coin vault 12. To prevent a side gate 24 from swinging freely and banging against the stall 10 and mobile coin vault 12 when a mobile coin vault 12 is installed or removed, a magnetic catch 46 is installed on a cross beam 20 to hold an open side gate 24 against the cross beam 20 and out of the way of a moving mobile coin vault 12. To prevent a side gate 24 from swinging beyond its closed position, each side gate 24 preferably includes a side gate stop 48 that engages each side gate's 24 respective vertical beam 18 when a side gate 24 is in a closed position.

Still referring to FIG. 1, in addition to the side gates 24 separating individual mobile coin vaults 12, each cage 22 includes a top gate 50 designed to close over a mobile coin vault 12, thereby preventing unauthorized entry. Each top gate 50 includes at least one spanning member 52 that extends across each cage 22 of the stall 10. The spanning members 52 are stabilized by at least one cross member 54. Each top gate 50 is coupled to a top beam 14 with hinges 26, and releasably coupled to an opposing top beam 14 with a locking latch 56.

At least one spanning member 52 and locking latch 56 for each cage 22 is oriented to align with a knob 58 on the horizontal sliding bar 40. By coupling the knob 57 to the locking latch 56 using a strap or other anchoring means (not shown), the horizontal sliding bar 40 is held in a locked position over the vertical sliding bar 32, thereby holding the bolt latches 28 of the side gates 24 in a locked configuration.

In order to more easily lift each of the top gates 50, each top gate 50 is equipped with a lifting mechanism 58. Each lifting mechanism 58 includes a spring 60 affixed to the hinge 26. The springs 60 are calibrated so that a minimum of lifting force is needed to urge a top gate 50 upward to an open position. To prevent the spring 60 from pulling a top gate 50 beyond a fully open position, each top gate 50 includes a top gate stop 62 calibrated to stop top gate 50 when it reaches a vertical position.

Still referring to FIG. 1, in order to assist a user when placing a mobile coin vault 12 in the stall 10, a pair of wheeled guides 64 are mounted to the top beam 14 adjacent a terminal cage 22. The wheeled guides 64 serve to bring the mobile coin vault 12 into alignment with the stall 10. Inside each cage 22, one or more top guides 66, and one or more bottom guides 68 are mounted on the top beam 14 and the bottom beam 16, respectively. The top guides 66 are sized to confine the mobile coin vault 12 to a single orientation in the stall 10. To prevent the top guides 66 from leaving marks on a mobile coin vault 12, the top guides 66 are made from a non-metallic material, or have a coating that avoids scratching.

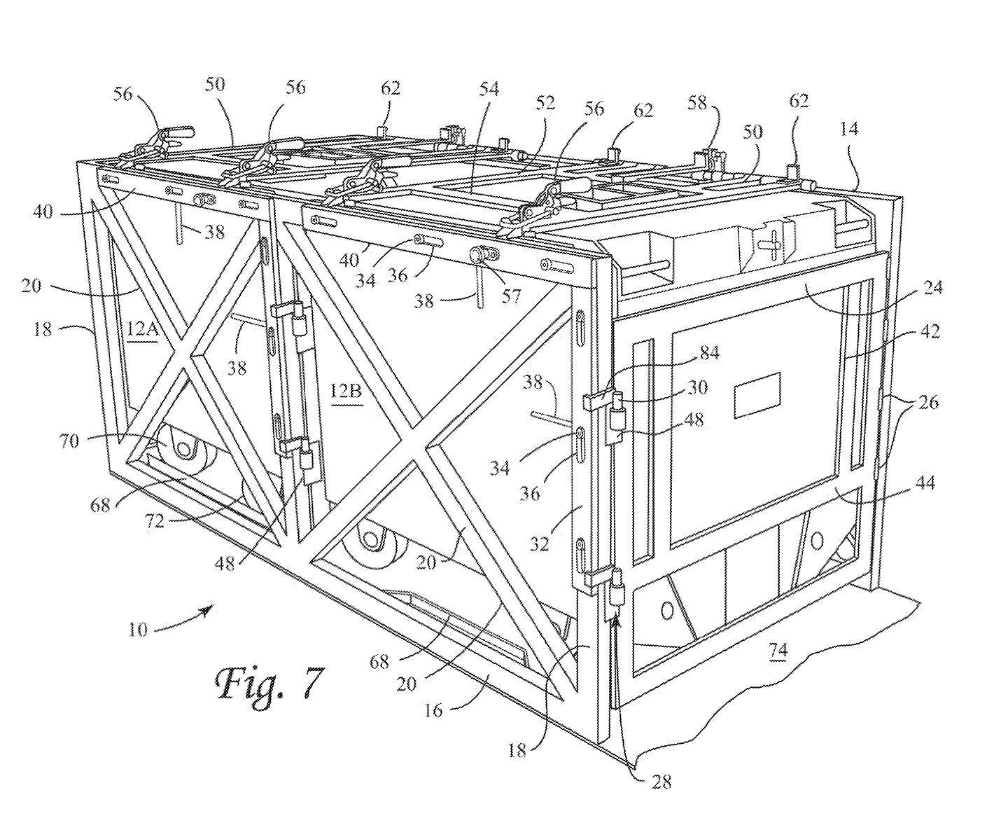

The bottom guides 68 are positioned to confine the front wheels 70 (FIG. 7) and rear wheels 72 (FIG. 7) of a mobile coin vault 12 parallel with the alignment of a mobile coin vault 12 in a cage 22. Typically, the front wheels 70 of a mobile coin vault 12 are fixed in a forward/reverse direction, while the rear wheels 72 swivel allowing a user to steer the mobile coin vault 12. In order to accommodate swiveling of the rear wheels 72, the bottom guides 68 are angled inward at the junction of a cage 22 in the vault 10. As the rear wheels 72 swivel, the mobile coin vault 12 is held in a steady direction of travel by the top guides 66. To provide a surface allowing the wheels 70, 72 to move smoothly, the stall 10 includes a floor panel 74 extending between all of the bottom beams 16.

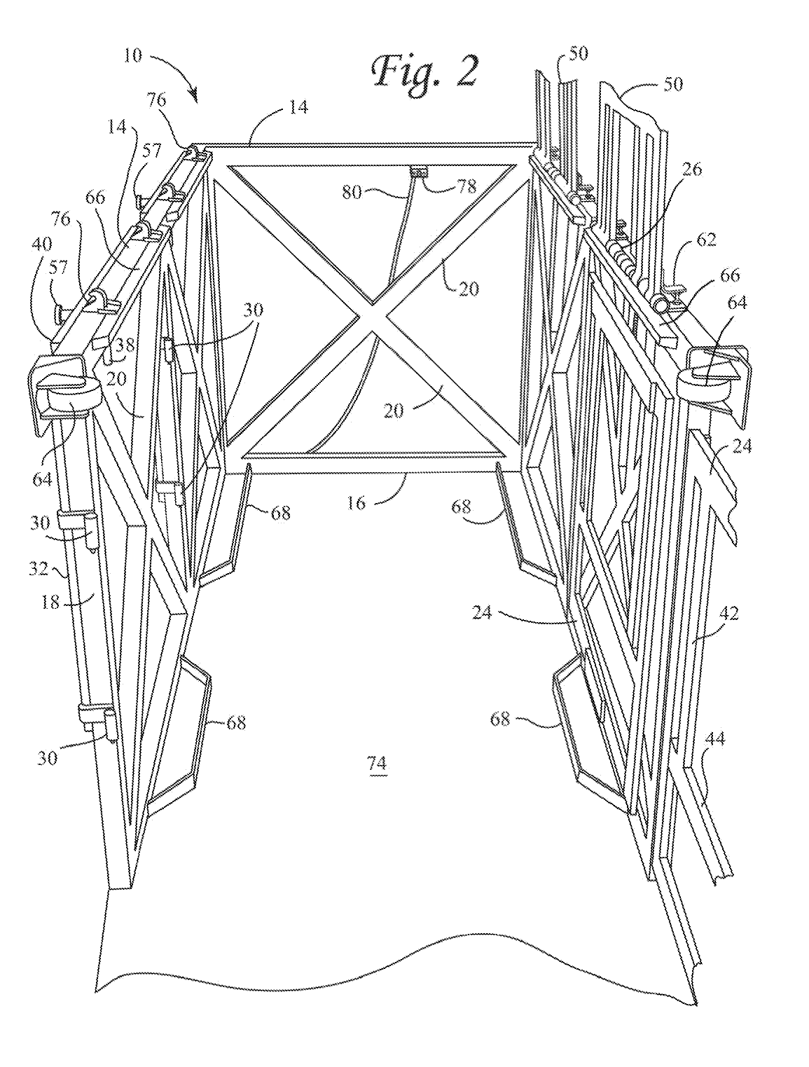

Referring to FIG. 2, the stall 10 is shown with a side gate 24 and top gates 50 open, ready to receive a mobile coin vault 12 (FIGS. 5-7). In this view, the side gate 24 of one cage 22 is held in place by the magnetic catch 46 (FIG. 1) of an adjacent cage 22. A side gate 24 having no adjacent cage 22 swings freely outside the stall 10. The locking latches 56 include hooks 76 anchored to the top beam 14 opposite the lifting mechanisms 58. With the side gates 24 and top gates 50 open, a user can roll a mobile coin vault 12 into the stall 10, first encountering the wheeled guides 64 that square the mobile coin vault 12 with the stall 10, and then along the top guides 66 as the bottom guides 68 urge the rear wheels 72 (FIG. 7) into alignment.

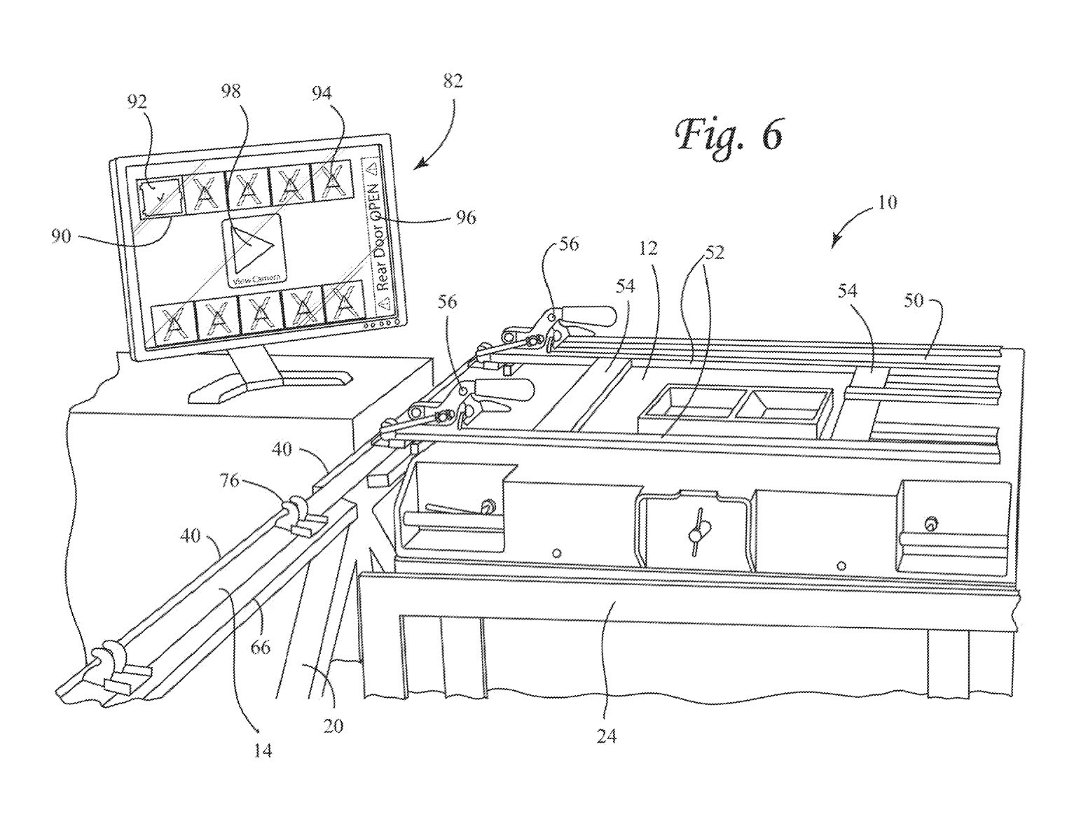

A sensor 78 is affixed to the stall 10, and is activated when a mobile coin vault 12 finishes entering a cage 22. Preferably, a sensor 78 is installed in each cage 22 and several sensors 78 may be connected in series and in communication with a cable 80 running from a preferred sensor 78 to a computer 82 (FIG. 6) for monitoring the installation and removal of mobile coin vaults 12 in the stall 10. The information gathered by a sensor 76 can be combined with time and date information, user identity, and other data to monitor and prepare reports regarding the installation and removal of multiple mobile coin vaults 12.

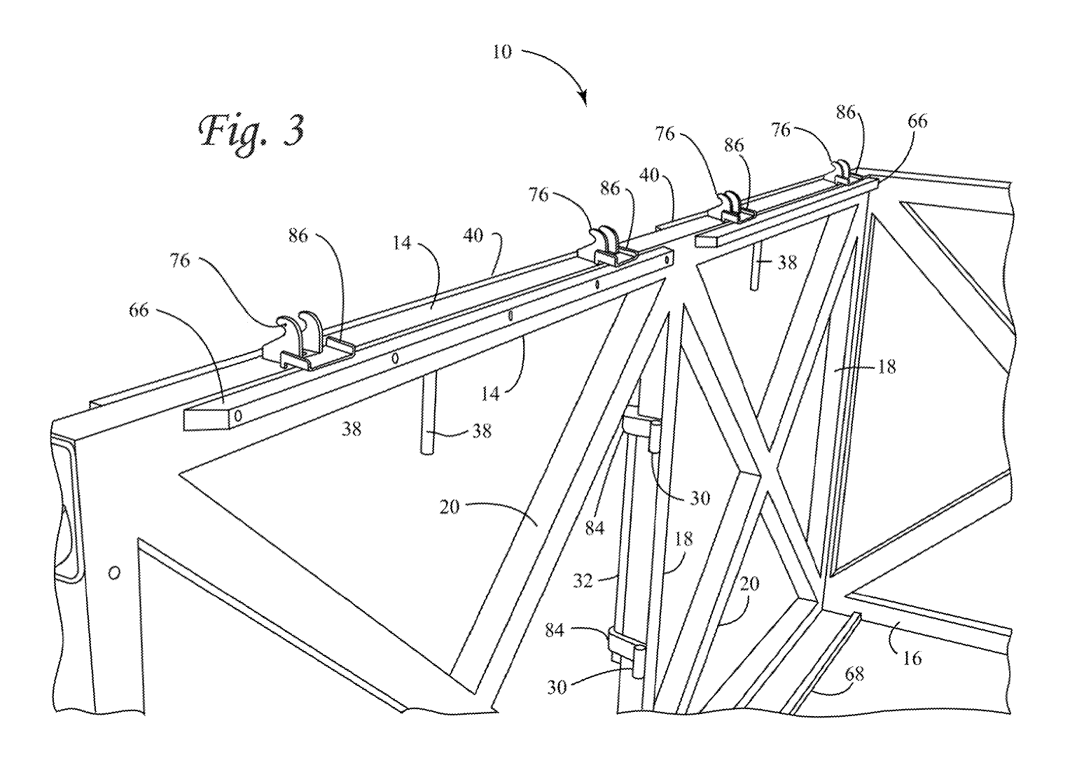

Referring to FIG. 3, the vertical sliding bar 32, horizontal sliding bar 40 and hooks 76 of the locking latches 56 are shown. The vertical sliding bar 32 includes bolt extensions 84 for locating the bolts 30 adjacent their respective vertical beams 18 as close to the closing side gate 24 as possible. This permits a user to raise and lower the bolts 30 using the handle 38 on a vertical sliding bar 32 without placing their hand inside the stall 10, which would risk injury from a moving mobile coin vault 12 (FIGS. 5-7). The horizontal sliding bars 40 and their handles 38, mounted on the exterior of the stall 10 similar to the vertical sliding bars 32, also avoid a user from having to reach into the stall 10.

The hooks 76 of the locking latches 56 are mounted inward or flush on the top beam 14. A series of locking latch guides 86 are disposed inward of the hooks 76 to promote alignment of the locking latches 56. The locking latch guides 86 are preferably disposed inward of the top guides 66 to prevent them from scratching a mobile coin vault 12 as it moves in and out of the stall 10.

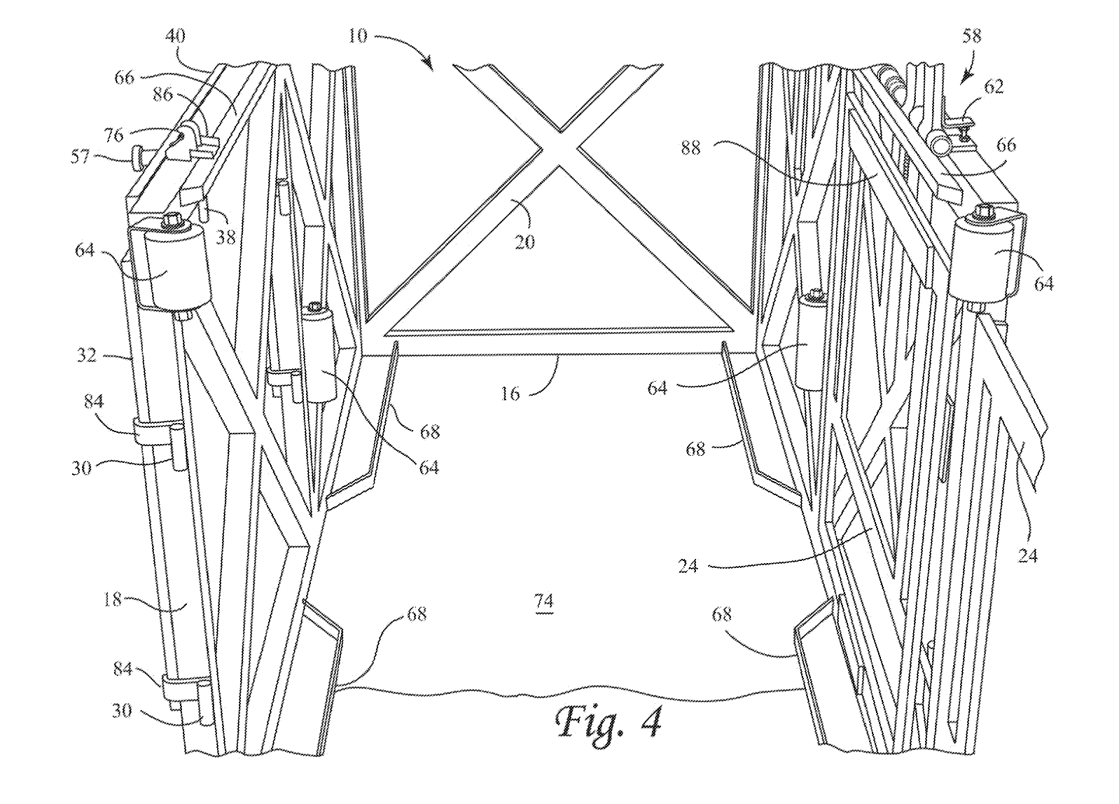

Referring to FIG. 4, in one embodiment the stall 10 may include extra structures to assist with smoothly installing and removing mobile coin vaults 12 (FIGS. 5-7), including additional wheeled guides 64 on the vertical beams 18 in the stall 10, and pads 88 on the side gates 24 to prevent a side gate 24 from scratching a mobile coin vault 12 when a user closes the side gate 24 to lock the mobile coin vault 12 in an individual cage 22. Having extra wheeled guides 64 allows users to more quickly install mobile coin vaults 12 and fill the stall 10.

Referring to FIG. 5, the stall 10 is shown with a user rolling a mobile coin vault 12 into position for installation. With the top gates 50 open and raised by the lifting mechanisms 58, and the side gates 24 open and held by the magnetic catches 46, a user can maneuver a mobile coin vault 12 into the stall 10. As a mobile coin vault 12 enters each cage 22 completely, it activates a sensor 78, alerting the user that it can now be locked in place.

Referring to FIG. 6, the stall 10 is shown with a mobile coin vault 12 installed therein and locked in position. With the mobile coin vault 12 inserted fully into the stall 10, the side gate 24 is closed and locked using the bolt latch 28. With the side gate 24 locked in position, and the horizontal sliding bar 40 positioned over the vertical sliding bar 32, the top gate 50 is closed over the mobile coin vault 12. Preferably, the spanning members 52 and cross members 54 of the top gate 50 are constructed to avoid obstructing raised top surface features of the mobile coin vault 12.

A computer 82 in communication with the sensors 78 displays confirmation that the mobile coin vault 12 is secured in its cage 22 in a stall 10. The illustrated embodiment contemplates two stall 10 having five cages 22 in series as shown in the computer 82 screen. The cages 22 are represented as box icons 90 having first indicia 92 reflecting the presence of a mobile coin vault 12. Second indicia 94 are present when a cage 22 is empty. Preferably, the computer 82 will access other information, such as detecting when a terminal side gate 24 is closed or opened to provide an alert 96 in the event of unauthorized entry. The computer 82 may also be connected to a camera (not shown) in the storage facility housing the stall 10 and provide a camera display 98 for viewing remote stalls 10 as an added security measure.

Referring to FIG. 7, the stall 10 is shown with two mobile coin vaults 12 installed therein and locked into position. The side gate 24 between the cages 22 is locked behind the first mobile coin vault 12A and a second mobile coin vault 12B is installed on the other side of that side gate 24. Another side gate 24 is closed and locked behind the second mobile coin vault 12B, and the top gates 50 are closed down on both mobile coin vaults 12A, 12B and locked in position with the locking latches 56. In this configuration, the mobile coin vaults 12A, 12B are held securely in the stall 10, which may be housed in a warehouse or similar location, or even aboard a vehicle to prevent the mobile coin vaults 12A, 12B from moving during transport.

The structure of the mobile coin vault clamping stall 10 having been described, its method use will now be discussed.

The stall 10 is initially installed in a preferred location, either in a storage facility or aboard a vehicle. The cable 80 is connected to a computer 82, which may be remotely installed in a different location. The computer can also be installed in the same location as the stall 10 to provide an assurance that the mobile coin vaults 12 are properly locked in the stall 10. In another embodiment, the computer may be installed onboard a vehicle and monitored by a driver or passenger as mobile coin vaults are being transported.

With the stall 10 installed in a preferred location and connected to the computer 82, the stall 10 is ready for use. A user opens one or more side gates 24, ensuring that they remain held against the magnetic catch when fully open. During this process the user also opens one or more top gates 50, allowing the lifting mechanisms 58 to assist with raising the top gates 50 and hold them in a vertical orientation. For a first use, once the side gates 24 and top gates 50 are open, the user manipulates a mobile coin vault 12 toward the stall 10.

The mobile coin vault 12 includes rigid front wheels 70 and swiveling rear wheels 72, allowing the user to make tight turns and align the mobile coin vault 12 with the stall 10. To the extent the mobile coin vault 12 is out of alignment with the stall 10, it will encounter the wheeled guides 64 which urge it into alignment. As the mobile coin vault 12 continues through the stall 10, the top guides 66 confine it to a proper alignment, while the bottom guides ensure the wheels are also properly aligned. Because the bottom guides 68 are angled at the junction of each cage 22, including, they urge any out of alignment rear wheel 72 into proper alignment as the mobile coin vault 12 enters the stall 10.

The user pushes the first mobile coin vault 12 through the stall 10 until it enters the last available cage 22 and activates the sensor 78. The sensor 78 signals to the computer 82 that the mobile coin vault is in position, changing the first indicia 92 in the box icon 90 to the second indicia 94. A person monitoring the computer can also watch installation of the mobile coin vault 12 with the camera display 98.

Once the mobile coin vault 12 is in position with the sensor activated, the user locks it in place by disconnecting the side gate 24 from the magnetic catch 46 and closing the side gate 24. As the side gate 24 approaches a vertical beam 18, the user raises the vertical sliding bar 32 by its handle, ensures that the side gate stop 48 is against the vertical beam 18 and lowers the bolts 30, thereby locking the bolt latch 28. The top gate 50 is then lowered over the mobile coin vault 12 so that the spanning members 52 approach and engage the locking latch guides 86. The locking latches 56 are then secured to anchor the top gate 50 to the top beam 14 opposite the lifting mechanism 58. To ensure that the cage 22 is not inadvertently opened, the horizontal sliding bar 40 is then slid over the vertical sliding bar 32, preventing the vertical sliding bar 32 from being raised. To preserve the position of the horizontal sliding bar 40, a strap or similar holder may be connected between the locking latches 56 and the knobs 57 on the horizontal sliding bar 40.

After the first mobile coin vault 12 is installed in the stall 10 and secured in a cage 22, a second mobile coin vault 12 can be installed in an adjacent cage 22. Once the second mobile coin vault 12 activates the sensor 78 in its cage 22, the computer will sense and report its installation. The second mobile coin vault 12 can then be anchored in position by closing and locking its respective side gate 24 and top gate 50. This process may be repeated until all cages 22 in a single stall are filled. With the mobile coin vaults 12 anchored in the stalls 10, they may be stored or transported as desired without the risk of rolling due to uneven surfaces or vehicular movement.

The foregoing description of the preferred embodiment of the Invention is sufficient in detail to enable one skilled in the art to make and use the invention. It is understood, however, that the detail of the preferred embodiment presented is not intended to limit the scope of the invention, in as much as equivalents thereof and other modifications which come within the scope of the invention as defined by the claims will become apparent to those skilled in the art upon reading this specification.

What is claimed is:

1. A mobile coin vault clamping stall, comprising:
a cage for confining a mobile coin vault;
the cage having a side gate and a top gate, the side gate and the top gate hingedly connected to the cage;
a releasable side gate latch operable from a first exterior side of the stall, and a releasable top gate latch operable from a second exterior side of the stall;
the releasable top gate latch positioned to lock the side gate latch when the top gate is closed over the mobile coin vault; and
wherein the cage prevents the mobile coin vault from rolling when the side gate is closed.

2. The clamping stall of claim 1 wherein multiple cages are connected in series.

3. The clamping stall of claim 2 wherein the side gate opens against a wall of an adjacent cage and is releasably secured thereto.

4. The clamping stall of claim 1 further comprising a vertical sliding bar coupled to the first exterior side of the stall.

5. The clamping stall of claim 4 further comprising a horizontal sliding bar coupled to the first exterior side of the stall, the horizontal sliding bar positioned to block and unblock movement of the vertical sliding bar.

6. The clamping stall of claim 5 wherein the top gate latch is coupled to the horizontal sliding bar in a position preventing movement of the vertical bar.

7. The clamping stall of claim 1 wherein the top gate comprises a lifting mechanism biasing the top gate to an open position.

8. The clamping stall of claim 1 further comprising wheeled guides positioned to orient the mobile coin vault for entry into the cage.

9. The clamping stall of claim 1 further comprising top guides for maintaining the orientation of the mobile coin vault.

10. The clamping stall of claim 1 wherein the cage includes bottom guides positioned to confine wheels of the mobile coin vault in a single direction.

11. The clamping stall of claim 1 further comprising a sensor arranged to detect the presence of a mobile coin vault in the cage.

12. The clamping stall of claim 2 further comprising multiple sensors, wherein a sensor is disposed in each cage.

13. The clamping stall of claim 1 further comprising a sensor coupled to a computer.

14. The clamping stall of claim 13 wherein the computer indicates when a mobile coin vault is installed in the cage.

15. The clamping stall of claim 13 wherein the computer indicates when a mobile coin vault is removed from a cage.

16. The clamping stall of claim 13 wherein the computer displays a live image of the stall.

17. A mobile coin vault clamping stall, comprising:
a first cage and an adjoining second cage, the first cage and the second cage each sized to confine a mobile coin vault;
the first cage having a first side gate and the second cage having a second side gate;
the first the cage and the second cage connected in series, such that the first side gate opens into the second cage;
the first cage having a first top gate and the second cage having a second top gate;
the first top gate governing locking of the first side gate and the second top gate governing locking of the second side gate;
the first cage and the second cage having guides for orienting the mobile coin vault relative to the stall; and
wherein when the first top gate is closed, the first side gate is locked, thereby confining the mobile coin vault in the stall.

18. The clamping stall of claim 17 further comprising a first sensor in the first stall and a second sensor in the second stall, the first sensor and the second sensor arranged to detect the presence of the mobile coin vault.

19. The clamping stall of claim 17 further comprising a computer arranged to report the presence or absence of a mobile coin vault in the first stall and a mobile coin vault in the second stall.

20. The clamping stall of claim 17 further comprising a computer arranged to provide an alert when a mobile coin vault is removed from the first stall, and when a mobile coin vault is removed from the second stall.
